(19) United States
(12) Patent Application Publication
(10) Pub. No.: US 2021/0342587 A1
(43) Pub. Date: Nov. 4, 2021

(54) CARD GAMING SYSTEMS

(71) Applicant: Zhen Hui Huang, Macau (CN)

(72) Inventor: Zhen Hui Huang, Macau (CN)

(21) Appl. No.: 16/861,252

(22) Filed: Apr. 29, 2020

(51) Int. Cl. G06K 9/00; G07F 17/32; A63F 1/06; G06K 9/46

(52) U.S. Cl. CPC G06K 9/00664; G07F 17/322; G07F 17/3241; G07F 17/3223; G06K 2209/01; A63F 1/06; G06K 9/00778; G06K 9/00362; G06K 9/4652; G07F 17/3211

(57) ABSTRACT

A card gaming system is provided, comprising: a table, at least one camera, and a processing device. The table has at least one betting area. The camera captures an image of the betting area. The processing device analyzes the image to identify each pile of chips based on diameters of the chips, to identify each chip from the identified piles of chips based on heights of the chips, to identify a chip value of each of the identified chips based on color, and to calculate a total value of bets based on a sum of the chip values.

### BACKGROUND OF THE INVENTION

### Field of the Invention

The present invention relates to card gaming systems, and in particular relates to casino card gaming systems.

### Description of the Related Art

In casinos, a player typically exchanges currency or some form of credit for casino chips. The player puts the chips as wagers at a gaming table for a game, such as blackjack, craps, roulette, or baccarat. A game operator, such as a dealer, pays out winning wagers with additional chips based on a game rule of the game, and confiscates the player's chips for losing wagers. However, there is currently no system that can efficiently obtain information on the use of chips. Thus, there is a need for a new card gaming system to overcome the said problems.

### BRIEF SUMMARY OF THE INVENTION

In light of the previously described problems, the present invention provides a card gaming system, comprising: a table, at least one camera, and a processing device. The table has at least one betting area. The camera captures an image of the betting area. The processing device analyzes the image to identify each pile of chips based on diameters of the chips, to identify each chip from the identified piles of chips based on heights of the chips, to identify a chip value of each of the identified chips based on color, and to calculate a total value of bets based on a sum of the chip values. Since the camera is provided to calculate the total value of bets and the chip box has RFID reader to identify the authenticity of chips, the card gaming system can efficiently obtain information on the use of chips.

### BRIEF DESCRIPTION OF THE DRAWINGS

FIG. 1 illustrates a card gaming system according to an embodiment of the present invention;

FIG. 2 illustrates a schematic side view of a card gaming system according to an embodiment of the present invention;

FIG. 3 illustrates a schematic bird's-eye view of a card gaming system according to an embodiment of the present invention;

FIGS. 4A and 4B illustrate a cross-sectional view of a docking hole according to an embodiment of the present invention.

### DETAILED DESCRIPTION OF THE INVENTION

The embodiment will be explained as follows. The following description is made for the purpose of illustrating the embodiment and should not be taken in a limiting sense. The scope of the invention is best determined by reference to the appended claims.

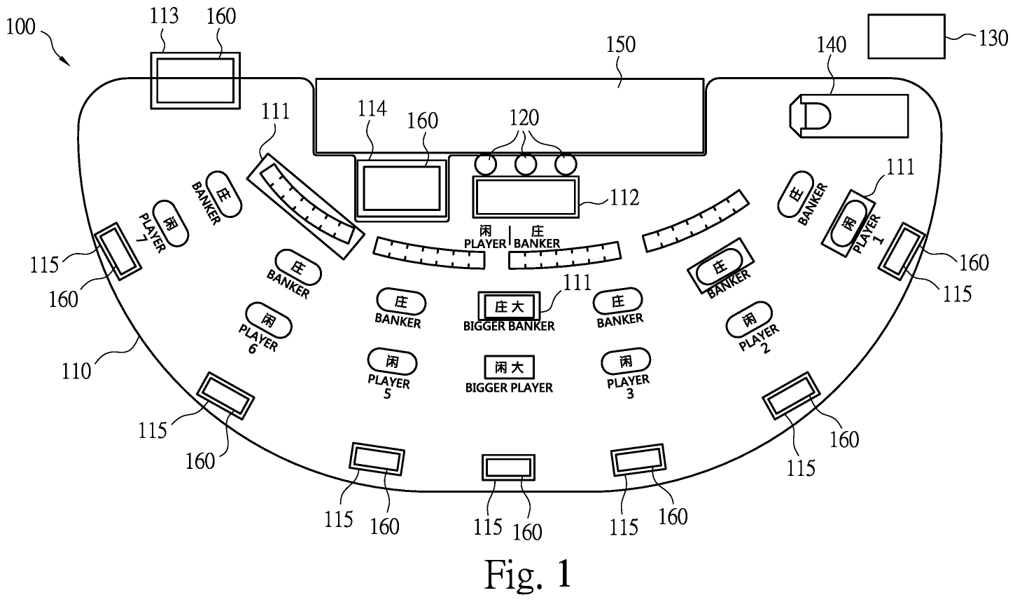

FIG. 1 illustrates a card gaming system according to an embodiment of the present invention. As illustrated in FIG. 1, the card gaming system 100 comprises a table 110, at least one camera 120, a processing device 130, a card shoe 140 and a chip tray 150. In some embodiments, the card gaming system 100 further comprises a plurality of monitors 160. Specifically, the table 110 has at least one betting area 111, a sensor area 112 and at least one display area, wherein the display area can be in a supervisor position 113, a dealer position 114 and/or at least a player position 115. Note that the numbers of the betting area 111, the sensor area 112 and the display area all can't be limited to these shown in FIG. 1, e.g., their numbers can depend on the needs of the games. The camera 120 is coupled to the processing device 130 and captures one or more image of the betting area 111 and then sends the image to the processing device 130. In some embodiments, the camera 120 can be disposed on the table 110 and/or the ceiling of the house, but it is not limited thereto. The camera 120 can be disposed on any position where the camera 120 is capable to capture the image of the betting area 111. In addition, the number of the camera 120 can't be limited to this shown in FIG. 1, e.g., it can depend on the needs of the games. Moreover, the card gaming system 100 further comprises a light emitting module. The light emitting module is disposed around each the betting areas 111, and lights around one or more of the betting areas 111 corresponding to a result of showdown. For example, if the banker wins in this round after a showdown, a red light will light around the banker's betting area 111.

The processing device 130 receives the image from the camera 120 and then analyzes the image to identify each pile of chips based on diameters of the chips, to identify each chip from the identified piles of chips based on heights of the chips, to identify a chip value of each of the identified chips based on color, and to calculate a total value of bets based on a sum of the chip values. Specifically, the processing device 130 can draw virtual lines on the betting areas based on the heights (or thicknesses) of chips to determine how many chips in each pile of chips in the betting area 111 on the table 110. The processing device 130 can draw virtual areas on the betting areas based on the diameters of the chips to determine how many piles of chips on the table 110. Furthermore, the processing device 130 determines a chip value of a chip based on a color of the chip itself. In some embodiments, the processing device 130 further recognizes face values printed on the chips based on the image to determine a chip value of each of the chips. Therefore, the processing device 130 capable to determine a chip value of each chip based on the height, diameter and color and then sums up all of the chip values to calculate total value of bets. Before a game session starts, the cameras 120 will capture the images of the chips and then send the captured image to the processing device 130 to count chip values of each betting area. The card gaming system 100 has default application programmable interfaces (APIs) for the card shoe 140 to call, this is, to start, hold and end a game session. The processing device 130 is capable to record bets, win and lose of each player at each game session. Once cards are played on the sensor area 112, the cameras 120 and the processing device 130 will stop calculating. When the dealer ends a game, the processing device 130 will record and compare the payouts based on the game rule. If the processing device 130 determines that the payouts mismatch game rules through the camera 120, the processing device 130 will send alerts to system managers, and hold a game session until the card gaming system 100 clears the alerts. Once the payouts are deployed correctly, then the card shoe 140 will be able to start a new game and deliver cards.

In various implementations, the processing device 130 may be a laptop, a netbook, a notebook, a smartphone, a tablet, a personal digital assistant (PDA), an ultra-mobile PC, a mobile phone, a desktop computer, a server, a printer, a scanner, a monitor, a set-top box, an entertainment control unit, a digital camera, a portable music player, a digital video recorder, or any other electronic device or system that processes data or employs one or more integrated circuit structures or devices formed using the disclosed techniques, as variously described herein.

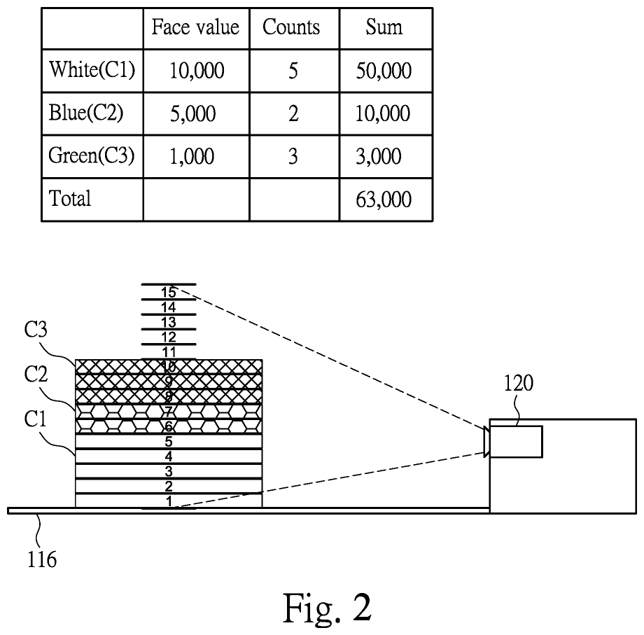

In FIG. 1, the plurality of monitors 140 are disposed in the supervisor position 113, the dealer position 114 and/or the player position 115 on the table 110 to display the chip counts and the chip values. The cameras 120 aim each the betting areas. FIG. 2 illustrates a schematic side view of a card gaming system according to an embodiment of the present invention. In the side view, the chips are set with different face value and color (e.g., the chip C3 (green)=1000; the chip C2 (blue)=5000; and the chip C1 (white)=10000). The processing device 130 draws virtual lines starting from the surface 116 of the table 110 on the image based on the height of one chip and recognizes colors of each chip. After the recognition, the processing device 130 counts number of each color and thus calculates sum of the total chip. In FIG. 2, the processing device 130 recognizes that there are five white chips (the face value is 10000), two blue chips (the face value is 5000) and three green chips (the face value is 1000) on the table 110 and sums up all of the face values of the chips to generate a total value of bets (the total value is 63000).

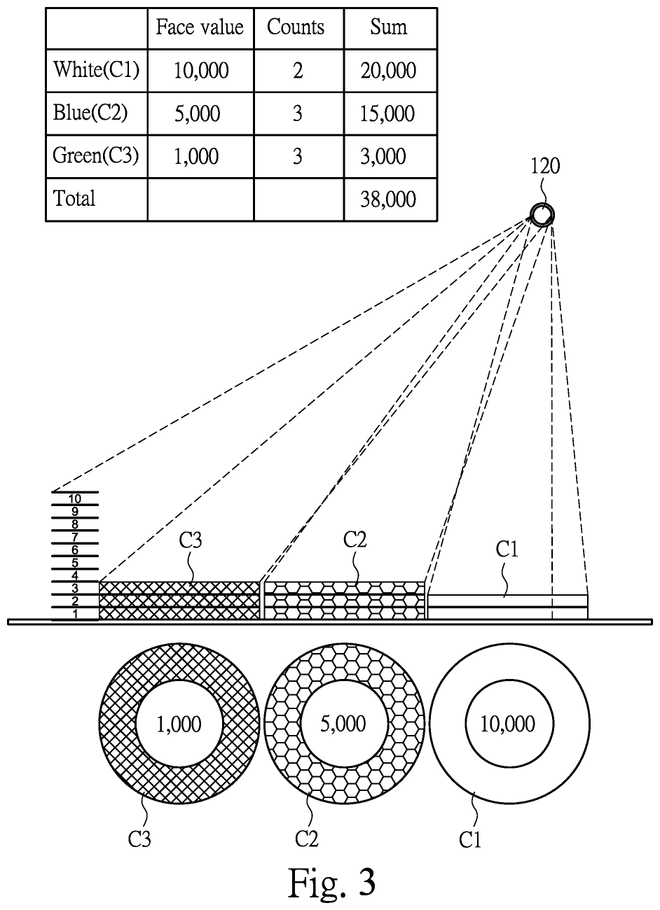

FIG. 3 illustrates a schematic bird's-eye view of a card gaming system according to an embodiment of the present invention. In the bird's-eye view, the chips are set with different face value and color (e.g., the chip C3 (green)=1000; the chip C2 (blue)=5000; and the chip C1 (white)=10000). The processing device 130 draws virtual lines starting from the surface 116 of the table 110 on the image based on the height of one chip. The processing device 130 further draws virtual circles based on the diameter of one chip and recognizes colors of each chip. In some embodiments, the processing device 130 recognizes face value printed on the chips based on the image. After the recognition, the processing device 130 counts numbers of each color and thus calculates sum of the total chip. In FIG. 3, the processing device 130 recognizes that there are two white chips (the face value is 10000), three blue chips (the face value is 5000) and three green chips (the face value is 1000) on the table 110 and sums up all of the face values of the chips to generate a total value of bets (the total value is 38000).

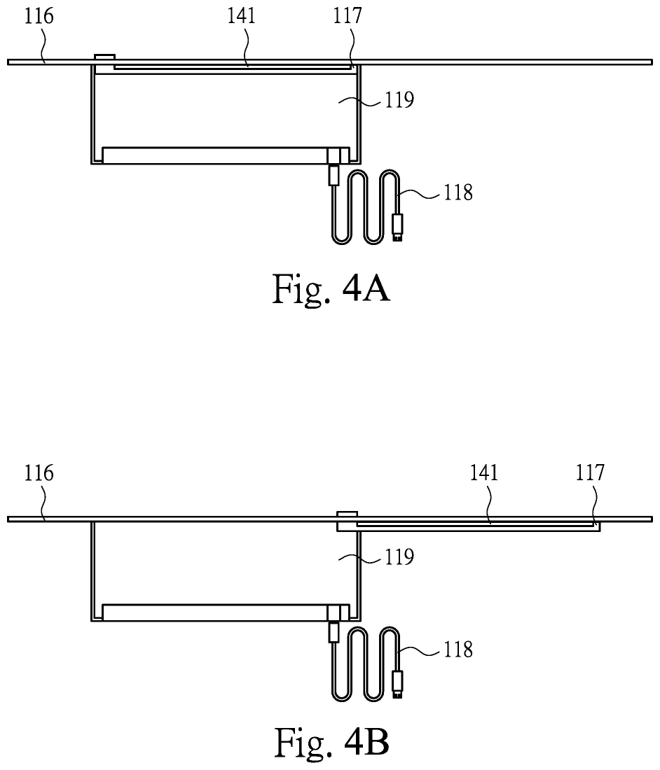

FIGS. 4A and 4B illustrate a cross-sectional view of a docking hole according to an embodiment of the present invention. The table 110 is designed to have docking holes 119 at each player positions 115 (shown in FIG. 1). The docking holes 119 are embedded with metal cases sinking below the surface 116 of the table 110. The docking holes 119 are embedded with a wireless communication system to report player information. Moreover, the table 110 is designed to have slide-in lids 117 each over the corresponding docking holes 119. The slide-in lids 117 each can be slid to expose the docking holes 119. The table 110 is designed to have a wire harness 118 in each docking hole 119 to provide wired and/or wireless charging and network connectivity. Optionally, one or more of the monitors 140 embedded on the tops of the slide-in lids 117 at the player position 115 can be an interactive panel 141. The interactive panel 141 is coupled to the processing device 130 and embedded with a customized software that (1) displays player information, player status, game status and/or game rules; (2) displays game table status, wherein the embedded software will call card shoe APIs to read, record, and display game results; (3) displays chip counts and values received from the camera 120 and the processing device 130; (4) connects to a chip box to read chip values, wherein the chip box has a RFID (Radio Frequency IDentification) reader for this purpose; and/or (5) connects to the chip box to detect whether there is a false chip, wherein the processing device 130 is coupled to a chip box that has a RFID reader to read chip values and detect a false chip. Furthermore, the interactive panel 141 is embedded with the customized software that connects to processing device 130 to call service such as an accounting service and/or a table service.

In conclusion, since the camera 120 is provided to calculate the total value of bets and the chip box has RFID reader to identify the authenticity of chips, the card gaming system 100 can efficiently obtain information on the use of chips. In addition, since the docking holes 119 are provided on the surface 116 of the table 110 for the placement of the chip box, the wired and/or wireless charging, and the network connectivity, the card gaming system 100 increases player comforts. Moreover, the interactive panel 141 over the docking hole 119 can encourage players to increase spending on additional services.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A card gaming system, comprising:
a table, having at least one betting area,
at least one camera, capturing an image of the betting area, and
a processing device, analyzing the image to identify each pile of chips based on diameters of the chips, to identify each chip from the identified piles of chips based on heights of the chips, to identify a chip value of each of the identified chips based on color, and to calculate a total value of bets based on a sum of the chip values.

2. The card gaming system as claimed in claim 1, wherein the processing device further recognizes face values printed on the chips based on the image to determine the chip values.

3. The card gaming system as claimed in claim 1, further comprising
a plurality of monitors, disposed in a supervisor position, a dealer position and a player position on the table to display chip counts and the chip values.

4. The card gaming system as claimed in claim 3, wherein one or more of the monitor at the player position is an interactive panel.

5. The card gaming system as claimed in claim 1, wherein the processing device records bets, win and lose of each player at each game session.

6. The card gaming system as claimed in claim 1, wherein, when the processing device determines that payouts mismatch game rules through the camera, the processing device sends alerts to system managers and holds a game session until the card gaming system clears the alerts.

7. The card gaming system as claimed in claim 1, wherein the table has a docking hole at a player position.

8. The card gaming system as claimed in claim 7, wherein the docking hole is embedded with a metal case sinking below a surface of the table.

9. The card gaming system as claimed in claim 7, wherein the docking hole are embedded with a wireless communication system to report player information.

10. The card gaming system as claimed in claim 7, wherein the table has a slide-in lid over the docking hole.

11. The card gaming system as claimed in claim 7, wherein the table has a wire harness in the docking hole to provide wired and/or wireless charging and network connectivity.

12. The card gaming system as claimed in claim 1, wherein the processing device is coupled to a chip box that has a RFID reader to read chip value in the chip box and detect false chip.

13. The card gaming system as claimed in claim 1, further comprising
a light emitting module, disposed around each the betting areas, and lighting around one or more of the betting areas corresponding to a result of showdown.
